(19) United States
(12) Patent Application Publication
(10) Pub. No.: US 2009/0317516 A1
(43) Pub. Date: Dec. 24, 2009

(54) PULVERLUENT MIXTURE THAT IS PALATABLE TO THE TASTE EVEN THOUGH SOME OF ITS INGREDIENTS MAY OTHERWISE TASTE BITTER IF TASTED SEPARATELY

(76) Inventor: Robert Newsteder, Sandown, NH (US)

Correspondence Address: HESS PATENT LAW FIRM, P.C., 9 MIRAMAR LANE, STAMFORD, CT, 06902, US

(21) Appl. No.: 12/143,306

(22) Filed: Jun. 20, 2008

(51) Int. Cl. A21D 10/00; A23L 1/302; A23P 1/08

(52) U.S. Cl. 426/72; 426/555; 426/284

(57) ABSTRACT

An edible item, which may be a food or nutritional supplement, that is palatable to the taste with a palatably pleasant aftertaste and is a mixture of pre-processed components in a granular or heterogeneous mixture. When added with a liquid such as water or milk, the heterogeneous mixture forms a batter that may be cooked into a shape indicative of a pancake. At least one of the pre-processed components segregates from the remainder of the cooked batter. It does not dissolve as a result of the addition of the liquid.

### BACKGROUND OF THE INVENTION

1. Field of the Invention

The present invention is directed to a food or nutritional supplement in the form of a heterogeneous, pulverulent blend, or ground powder, which is palatable to the taste, despite containing ingredients that taste bitter if those ingredients were separated apart from the mixture. There is no need to mask the undesirable tastes with sugar and/or flavorings in accordance with the invention, because of the manner in which each ingredient or group of ingredients of each component of the blend is pre-processed, i.e., coating them with baked batter.

2. Discussion of Related Art

Breakfast is the most important meal of the day. The most commonly consumed breakfast foods include: uncooked cereals, prepared cereals, ready to eat snack type breakfast items, eggs, egg substitutes, and meats such as bacon, toast, and many others. The main categories of breakfast type meals are cereals, eggs and pancakes. This does not include side foods such as bacon, sausage, toast or pastries.

Many food products claim to be high in beneficial components and low in harmful ingredients, but these type products usually taste undesirable and leave an undesirable aftertaste. There are also some commercially available that products are high in some beneficial components, such as protein but low in others, such as fiber. There are breakfast drinks that contain many beneficial components, but which lack the bulk and fiber.

Nutritional additives (as that term is used in the patent application) improve or maintain the nutritional quality of a food item and involves the addition of vitamins, minerals, amino acids, fatty acids, other pure chemical compounds and any combination thereof. For instance, nutritional additives restore nutrients to levels found in the food before storage, packaging, handling and processing, such as the enrichment of grain products (e.g., wheat germ). Nutritional additives may improve the nutritional status or correct nutritional inferiority in a food item that is to replace a more conventional nutritional food, such as is done for fortification of breakfast drink substitutes with folacin and vitamin C. Some nutritional additives provide more than just nutrient advantage. For instance, vitamins C and E provide antioxidant properties and carotene provides color. The form that nutritional additives take (e.g., powder, encapsulated in gelatin, emulsified in oil) depends upon the type of application and are often protected by protective additives such as antioxidants. The form selection for the nutritional additive may depend upon the stability of the vitamin preparation and its miscibility with the intended food matrix.

It is desired to provide a breakfast food that has a palatable taste (that is not bitter) and can readily accommodate inclusion of high nutrition content ingredients that would taste bitter if tasted separately apart from their incorporation into the breakfast food. It is desired that such a breakfast food provide a pleasant aftertaste in the mouth.

### SUMMARY OF THE INVENTION

One aspect of the invention relates to a unique combination of cereals, grains, vitamins and other nutritional components that, when added to skim milk or fat free powdered milk and egg whites or egg substitutes, combines to offer the consumer the equivalent of an entire breakfast of cereal, bacon and eggs, whole wheat bread and the like, but without the cholesterol, fat, added sugar, and other undesirable ingredients. Such a final product is palatable to the taste and has a pleasant aftertaste in the mouth, even though the final product contains ingredients that are not palatable to the taste if tasted separately.

Another aspect of the invention is to deliver complete nutrition with good taste (i.e., non-bitter taste) in a convenient versatile format, but without causing undesirable after taste and without giving rise to belching/burping to relieve stomach gas. The invention has a composition that allows for it to be cooked as a pancake, crêpe, scrambled, baked and micro-waved. Further, the invention can be used as a substitute in whole or in part in numerous recipes that use flour as an ingredient, such as pie crusts, pastries, cakes, brownies, cookies. As a result of such substitution, the ensuing end product is more nutritious than without the substitution. The invention is a cost effective delivery of nutrition on a per volume basis in powder form.

There are five basic taste sensations—bitterness, saltiness, sourness, sweetness and umami. The bitter taste is perceived by many to be unpleasant, sharp, or disagreeable. Saltiness taste is produced primarily from the presence of sodium ions, which can pass through ion channels in the tongue to generate an action potential. Sourness taste detects acidity and the mechanism is similar to that for detecting saltiness except that hydrogen ion channels detect the concentration of hydronium ions that are formed in acids and water. Sweetness is produced by the presence of sugars, some proteins and a few other substances and is often connected to aldehydes and ketones, which contain a carbonyl group. Sweetness is detected by a variety of G protein coupled receptors coupled to the G protein gustducin found on taste buds. Unami taste is produced by compounds such as glutamate and commonly found in fermented and aged foods, but also in unfermented foods such as walnuts, grapes, broccoli, tomatoes, mushrooms and, to a lesser degree, meat.

The invention provides a final product that is palatable to the taste. The term palatable means acceptable to the taste, i.e., sufficiently agreeable in flavor to be eaten. Depending upon one's viewpoint, the present invention may be considered more than just merely palatable, i.e., appetizing, tasty even savory. However, there is no noticeable bitter taste even though some of the ingredients, if tasted separately, may taste bitter. For example, wheat germ may taste bitter due to its fiber. Vitamins, if taken in tablet form (even crushed) taste bitter.

The final product in accordance with the invention is a blend or “mixture”, as opposed to a compound or homogeneous composition, in that the ingredients do not dissolve into the added liquids. The “mixture” will, when standing in a batter, settle out and in that sense appear to be in suspension in the batter, which is quite viscous (at least analogous to conventional pancake batter). This indicates that the components do not dissolve into the batter. Because the ingredients do no enter into a compound, the taste of specific ingredients remains and the consumer is treated to a food product that is not only as nutritious as some other products claim to be, but it also retains the good taste. This is in part attributed to there being a greater quantity of ingredients present in the unique combination that are palatable to the taste than ingredients that taste bitter.

The final mixture is easy to prepare. The invention enables the consumer to add a prepared mixture (the invention) with egg whites or egg white substitutes and skim milk or other liquid to make a batter that can be cooked as easily as pancakes, but which provides all the good nutrition desired in a total meal, and none of the bad ingredients.

### BRIEF DESCRIPTION OF THE DRAWING

For a better understanding of the present invention, reference is made to the following description and accompanying drawings, while the scope of the invention is set forth in the appended claims:

FIG. 1 is an advertisement depicting an isometric view of a bottle containing the heterogeneous mixture in accordance with the invention.

FIG. 2 is an advertisement depicting an isometric view of bottles each containing the heterogeneous mixture of the invention with powdered eggs and powered milk mixed in. The product is prepared by simply adding water to a prescribed line, shaking well and pouring, etc.

FIG. 3 is an advertisement depicting an isometric view of a pack containing separate individual portions of the heterogeneous mixture of the invention such that each portion may form a serving of crêpes from each of the individual portions when mixed with an appropriate number of egg whites for the serving and an appropriate amount of skim milk for the serving. This may also be available with powdered milk and eggs so that the user need only add water. The advantage of this kind of packaging is for extremely long shelf life, for years.

FIG. 4 is an advertisement depicting an isometric view of a package containing a plurality of flat crêpes that may be rolled together with filling in a rolled shape, the flat crêpes being a cooked product of the heterogeneous mixture in accordance with the invention and either egg whites and skim milk or powdered egg whites, powdered skim milk and water. This may be sold as a refrigerated or frozen product such as frozen waffles.

FIG. 5 is an advertisement depicting an isometric view of a package containing rolled crêpes with filling, each of the crêpes being a cooked product of the heterogeneous mixture in accordance with the invention and either egg whites and skim milk or powdered egg whites, powdered skim milk and water.

This product can be popped into the microwave-ready to roll in 30 seconds (longer if frozen). This product, which depicts a school bus suggest its convenience as a product directly mainly to children who skip breakfast, etc. The object is to pop one into a microwave and give it to the child to eat on the bus or on the way to school. This is similar to the convenience of boxed apple pie that is heated in a like manner by fast food restaurant chains.

FIG. 6 is an advertisement depicting an isometric view of liquid tight containers that contain the heterogeneous mixture in accordance with the invention and either egg whites and skim milk or powdered egg whites, powdered skim milk and water. Each container equals one adult portion as listed on the nutritional content of the package. These liquid containers are refrigerated.

FIG. 7 is an advertisement depicting an isometric view of a box containing rolled crêpes, each of the crêpes being a cooked product of the heterogeneous mixture in accordance with the invention and either egg whites and skim milk or powdered egg whites, powdered skim milk and water. This product may be offered as a weight control product due to the low calorie value (2 points rating for weight watchers). This product is refrigerated or frozen.

FIG. 8 is a depiction of a one-quart bottle with the same mixture as in FIG. 6 and may be sold next to egg substitute products in a refrigerated display case.

### DESCRIPTION OF THE PREFERRED EMBODIMENT

A mixture to form a batter of a breakfast food in accordance with the invention includes nutritional additives with preferably a minimum of four components in granular form, such as cereals, leavening agents, crackers or cookies, and wheat germ. The finished food product is pulverulent or ground into a fine powder, mixed in prescribed ratios and thoroughly blended or dispersed into a heterogeneous mixture or blend so that each unit of the mixture contains substantially equal amounts of the powdered parts. This is then added to the egg and milk products to make a batter. The mixture does not dissolve into one mixture to become indistinguishable from the rest of the mixture, but rather disperses into the mixture to maintain its separate identity and thereby retain its flavor, nutritional content and texture. The mixture is then cooked into a finished food product.

An analysis of the finished food product reveals that the finished food product includes ingredients such as wheat, enriched flour, niacin, iron, and sugar, for instance. The ingredients come from the components of the invention that were mixed together. Each of the components in the mix may be prepared as a baked product and then ground, where the baked product contains the nutritionally desirable components such as vitamins and minerals and proteins. These nutritious components may be mixed into a batter containing flour and other ingredients. The batter is baked into thin strips or flakes. These are then ground into a coarse powder-like consistency and added to the mix. Each ground particle has a share of the nutritious elements for the baked product. The exact nutritional content to be added by each nutritious component may vary to include higher vitamin content such as Vitamin D that had been shown to be helpful in Autism, etc.

Each of the components of the invention adds something special that makes it unique when combined into the mixture. One is for flavor, one is for ease of baking, one or more is for added vitamin and supplemental nutrition, one is for fiber, and so forth. When combined with egg whites, and milk, the end result is a meal that is highest in protein, fiber, vitamins, supplement and which calorie for calorie, provides the best nutrition of any food, processed or natural, that can be consumed as far as the inventor is aware.

For purposes of representation, the invention includes four components plus an example of extra ingredients that may be incorporated to the basic finished invention for special applications. Such applications may be for use of the invention in conjunction with weight loss programs or weight gain programs or for extra nutrition for consumers recovering from specific illnesses. The following are examples of the four components, their ingredients and what the component product is.

Each of the components, with the exception of number 4, can be consumed without the need for further processing. Accordingly, it can be used in combination with milk, (without the eggs) as a nutritional beverage. Alternatively, it can be used with water, fruit juice, and may include other powdered components such as powdered milk, eggs, etc.

Component 1: Wheat Germ and Additives: Not raw. Ground.
INGREDIENTS: Wheat Germ, vitamin E, Acetate, Folic Acid
PRODUCT: High Dietary Fiber, Protein (Wheat germ is not as high in protein as egg whites) and Supplement Source

Component 2: Flavorful Crackers Baked: Ground.
INGREDIENTS: Enriched Flour (Wheat Flour, Niacin, Reduced Iron, Thiamine Mononitrate (VitaminB1), Riboflavin (Vitamin B2), Folic Acid, Sugar, Whole Grain Wheat Flour, High Fructose Corn Syrup, Soybean Oil, Honey, Calcium Carbonate (Source of Calcium), Leavening (Baking Soda, Calcium Phosphate), Partially Hydrogenated Cottonseed Oil, Salt, Emulsifiers (Soy Lecithin), Vanillin-An Artificial Flavor, Cornstarch
PRODUCT: Crackers/Cookies that are nutritious and flavorful.

Component 3: Roasted High Vitamin Content Cereal: Ground
INGREDIENTS: Whole Grain Wheat, Sugar, Calcium Carbonate, Whole Grain Brown Rice, Corn Syrup, Salt, Vitamin C (sodium ascorbate), monoglycerides, annatto extract color and beet juice concentrate, Vitamin E (tocopheryl acetate), Zinc and Iron (Mineral nutrients), A B Vitamin (niacinamide), A B Vitamin (calcium pantothenate), Vitamin B2 (riboflavin), Vitamin B6 (pyridoxine hydrochloride), Vitamin B1 (Thiamin Mononitrate), A B Vitamin (Folic Acid), Vitamin A Palmitate, Vitamin B12, Vitamin D, preservative BHT.
PRODUCT: Prepared Type Cereal with added vitamins

Component 4: Baking components
INGREDIENTS: Enriched Flour Bleached (wheat flour, niacin, iron, thiamin, mononitrate, riboflavin, folic acid), canola oil, dextrose, sugar, baking soda, sodium aluminum phosphate, salt, tricalcium phosphate, monocalcium phosphate, datem.
PRODUCT: Baking (not processed fully components)

Extra Components: Additives for increased nutrition (special applications)
INGREDIENTS: Soy Protein Isolate, Soy Lecithin, Natural Flavor
PRODUCT: High Potency pre-processed nutritional additive.

If one were to determine what the total of each individual ingredient was determined as a combined value of all the ingredients, and that amount of each ingredient was mixed into a mixture, without the benefit of the pre-processing, the end result would be a mixture that would not have the desirable taste, consistency and appeal of the invention.

For purposes of explanation, if one were to mix certain ingredients of paints together, the end result from the mixing might be anticipated to be green as the color you would get by mixing yellow with blue, but the end result may instead be a muddy looking gray.

The same is true with this invention. Pre-processed foods are each outstanding in their own category. However, by grinding and blending them in the correct proportions and then mixing the mixture with the egg white and thinner such as skim milk, the consumer ends up with a truly unique food product.

The resulting consumable final product is in a class by itself. Not a cereal, not just eggs, not a meat product, not a pastry, not a nutritious shake, but a single composite meal that provides total nutrition. Such a final product is palatable to the taste and provides a palatably pleasant aftertaste.

Consumers have very limited choices for breakfast, as mentioned above. The problem with eggs is cholesterol. Egg yolks are very high in cholesterol. Eggs are very high in protein, but lack vitamins, supplements and fiber. The combination of the invention with egg whites and skim milk thereby provides the consumer with virtually all of the necessary nutritional components to sustain life. With the addition of very little else, one could survive almost on a diet of this invention in combination with the other parts.

In accordance with the invention, the ingredients of the single composite meal include whole grain wheat, wheat germ, whole grain brown rice, enriched wheat flour, Vitamins A palmitate, B12, D, B6 pyridoxine hydrochloride, B1 thiamin mononitrate, B2 riboflavin, C sodium ascorbate, E tocopheryl acetate, corn syrup, sugar, soybean oil, salt, niacin, baking soda, beet juice concentrate, canola oil, emulsifiers, honey, niacinimide, monoglycerides, folic acid, tricalcium phosphate, zinc, vanillan—an artificial flavor, BHT—a preservative to preserve freshness. The final product does not have to have BHT.

In accordance with the invention, a mixture of ingredients is blended and baked to form a flake like product such as corn flakes, where the ingredients include powdered vitamins, minerals and other essential supplement are added to a flake type batter the same way as corn flakes are made. Several brands of this type of “nutritious” flaked baked product are sold commercially. The purpose of first combining the nutritious ingredients into a batter that can be baked into a flake form is that the nutritious ingredients often have an undesirable taste, when eaten separately. Most nutritious ingredients in this category are either sold as tablets, capsules or in drink mixes that are flavor enhanced, often with sugar, artificial flavoring and/or artificial sweeteners.

The advantage of first combining the nutritious components into a batter and baking them into a flake is that the final product can be ground and added to the mix without the undesirable taste of the individual nutritious component. Once baked into the flake, each of the nutritious components is essentially coated with the baking component and do not dissolve easily, but are easily digested.

Recipes of nutritious ingredients can be varied for specific need, including, but not limited to High B Complex Vitamins, or High Calcium content, etc. Imagine taking a vitamin C tablet, crushing it up to a very fine powder, mixing it into a batter of dough that was prepared to make crackers, After the cracker is baked, the cracker is again ground up into a powder and added to the mixture as described in the invention.

The graham crackers, which are added primarily for flavor could be baked in the same way as regular graham crackers with nutritious components added.

Wheat Germ is available in bulk from a wide range of sources. Also other fiber components can be added, other than wheat germ. Bran might also be used.

Baking ingredients may include a raising agent to lighten the texture and increase the volume of the baked product. Baking powder, baking soda and yeast are examples of common leaveners or leavening agents that may be used. When mixed with a liquid, they form carbon dioxide gas bubbles, which cause the batter or dough to rise before or during the cooking or baking process. The batter may be leavened by air beaten into egg whites so that when heated, the egg whites cook and set, trapping the air inside and creating a light, airy cake.

When one bakes an apple pie and replaces the flour with the present invention, the results are outstanding. The apple pie baked is really delicious and each slice (⅛ of a 9 inch pie) is like eating a wholesome breakfast with virtually no sugar, cholesterol, etc., provided the mix of the invention has powdered eggs and powdered milk as shown in the pre-mix bottles that only need water added. When replacing flour called from by a recipe with the mixture, it is not necessary to add egg whites and/or skim milk. Only a little egg white is needed as a binder, if at all. For instance, the pulverulent or dry powder mixture of the present invention may replace flour, which would otherwise go into forming the pie shell.

Turning to the drawing, the present invention may be packaged in manner suited for convenience of the consumer.

Turning to FIG. 1, a vacuum-sealed bottle 10 may contain the heterogeneous mixture 12 in accordance with the invention. A lid closes the opening of the bottle and is opened to break the vacuum and permit access to the interior of the bottle 10 and thus to the heterogeneous, pulverulent mixture 12. Either egg whites with skim milk, or powered egg whites with powdered skim milk, and water are added to one or more servings of the heterogeneous, pulverulent mixture 12 in roughly equal portions and mixed together to form a batter. The batter is then cooked on a hot surface of a pan to form a pancake or pancake crêpe. A filling may be added, such as fruit and nuts, to the pancake or pancake crêpe. Cooking is complete when the liquid in the batter is substantially cooked off (disappears). Here, the reference to the liquid being cooked off in the batter refers to just the water portion of the skim milk and egg whites being cooked off.

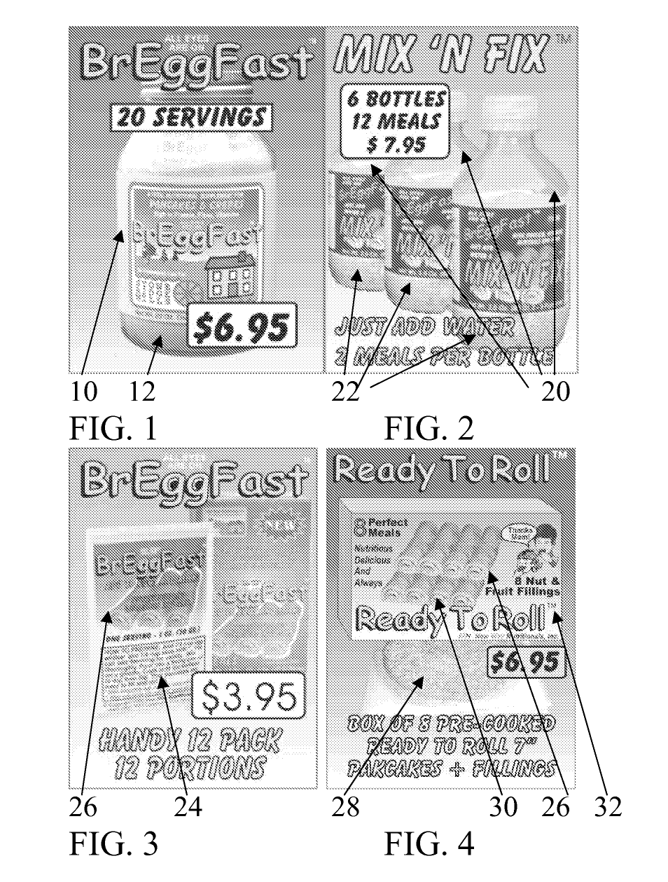

Turning to FIG. 2, non-vacuum sealed bottles 20 (there are also other types of non-vacuum sealed conventional bottles of ready-to-mix for pancakes that may be used with the invention) are shown that contain a heterogeneous, pulverulent mixture 22 that is substantially the same as the heterogeneous, pulverulent mixture 12 of FIG. 1 except that powdered egg whites and powdered skim milk is also mixed into the mixture in an appropriate ratio for the servings. Water is added to form the batter and cooking of the batter proceeds in a manner in the same manner as in the embodiment of FIG. 1. Unscrewing the bottle lids to break the seal provides access to the bottle contents.

Turning to FIG. 3, individual packages 24 are provided each containing one or more servings only of the heterogeneous, pulverulent mixture 12 (or blend) of FIG. 1 to form a serving of rolled pancake crêpes 26 in the same manner as for the embodiment of FIG. 1. However, there is no need to measure the quantity of heterogeneous, pulverulent mixture 12 of FIG. 1 to use since the package 24 contain the appropriate serving quantities. These are airtight pouches, which may be the same as conventional kinds of powdered instant breakfast type products.

Turning to FIG. 4, flat pancakes 28 in a box 32 are pre-cooked as the purulent mixture 12 of the embodiment of FIG. 1 with either egg whites and skim milk or powdered egg whites, powdered skim milk and water. The pancake crêpes 26 may have a filling 30 spread on them so they can be rolled into the shape of a rolled pancake crêpe 26. If desired, the pancake crêpes 26 may be taken out of their box 32 and heated in a microwave prior to spreading the filling on them and rolling them These may be sold either frozen or refrigerated.

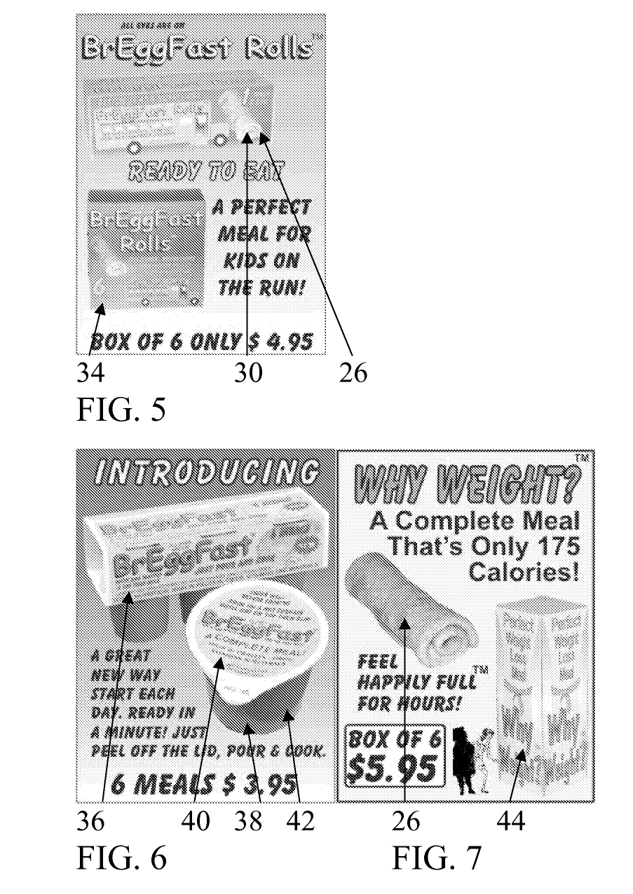

Turning to FIG. 5, rolled pancake crêpes 26 with fillings 30 (such as fruit and nuts) are packaged in a container 34. If desired, the rolled pancake crêpes with filling may be heated in a microwave prior to serving. These may be sold either frozen or refrigerated.

Turning to FIG. 6, a three-pack 36 is shown of pourable containers 38 having peel-off lids 40. The contents 42 of the pourable containers 38 is the heterogeneous, pulverulent mixture 12 of the embodiment of FIG. 1 in a quantity suited for the service size of the pourable container 38 together with either egg whites and skim milk or powdered egg whites, powdered skim milk and water. In effect, the pourable containers 38 each contain the batter of the present invention and are thus ready to pour out onto a hot surface of a pan for cooking into a pancake or pancake crêpe. Preferably the lids 40 are attached to the pourable containers 38 in a liquid tight manner. The pourable containers 38 should be refrigerated until use. These may be sold refrigerated.

Turning to FIG. 7, a box 44 contains a plurality of pancake crêpes 26 with or without fillings and is ready-to-eat after heating. These may be sold either frozen or refrigerated.

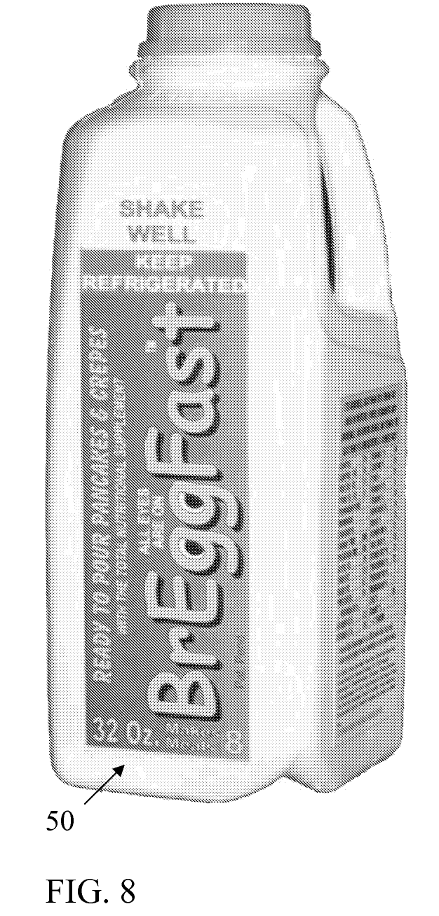

Turning to FIG. 8, an opaque, liquid-tight container 50 contains batter in accordance with the invention that is ready to pour onto a hot surface for cooking or baking the batter. The batter has the heterogeneous, pulverulent mixture 12 combined with either egg whites and skim milk or powdered egg whites, powdered skim milk and water. The water may be filtered and purified to take out contaminants.

Alternatively, whole eggs (including the yolks) may be used instead of just egg whites. Further, any other kind of milk (whole, low fat, etc.) may used to replace the skim milk. However, replacing just egg whites by whole eggs is less desirable, because using just egg whites and skim milk avoids adding levels of cholesterol to the product that would otherwise be reached from adding egg yolks (in addition to egg whites) and replacing skim milk with whole or low fat milk.

In each of the embodiments, egg whites and skim milk (or powdered egg whites, powdered skim milk and water) are mixed with the purulent mixture of the invention to form the batter. However, whole eggs (yolks and egg whites) could be used in place of just egg whites. Further, any kind of milk (whole, reduced fat, soy milk, etc) may be substituted for skim milk (powdered or not).

FIGS. 1-8 show advertisements. The present invention also envisions advertising by promoting the same points raised in the advertisements to appeal to consumers to purchase the heterogeneous, pulverulent mixture of the invention either in powder form, to which eggs and milk may be added or just water if powdered eggs and powdered milk are already added, or in batter form or in pancake form or in rolled pancake form with or without fillings spread onto the pancake. The pancakes would be packaged and refrigerated, together with the fillings in the same package. Further, the contents of the package may be apportioned to provide an integral number of serving quantities. Finally, the nutritious and beneficial qualities of the invention (high vitamin content, high dietary fiber, high protein and appealing taste) may be promoted through advertising.

Many food recipes call for the use of flour. The dry, heterogeneous, pulverulent mixture of the present invention may replace flour in such recipes.

The mixture can be cooked as a crepe or pancake, scrambled as eggs, baked as in a cupcake tin, and even microwaved in a cardboard cup.

While the foregoing description and drawings represent the preferred embodiments of the present invention, it will be understood that various changes and modifications may be made without departing from the spirit and scope of the present invention.

What is claimed is:

1. An edible item, which is palatable to the taste, with nutritional additives that when tasted separately apart from the edible item are not palatable to the taste, comprising a heterogeneous mixture of a plurality of components each in a granular and powder state that disperse in a liquid to form a batter that is palatable to the taste upon cooking the batter at elevated temperatures to form the edible item, each of the components having ingredients that include the nutritional additives, the ingredients of a first of the components including a cereal coating in granular form, the ingredients of a second of the components including a leavening agent in granular form, the ingredients of a third of the components including a cracker or cookie in granular form, a fourth of the components including wheat germ in granular form, the nutritional supplements being suited to improve or maintain nutritional quality and being selected from a group consisting of vitamins, minerals, amino acids, fatty acids, pure chemical compounds, and any combination thereof.

2. The edible item of claim 1, wherein the heterogeneous mixture also includes additional ingredients selected from a group consisting of powdered milk, powdered eggs and any combination thereof.

3. The edible item of claim 1, wherein the heterogeneous mixture also includes additional ingredients selected from a group consisting of vitamins, fiber, nutrients and any combination thereof but at quantities that do not noticeably alter a taste of the heterogeneous mixture.

4. The edible item of claim 1 in combination with a liquid tight container, the heterogeneous mixture being mixed with the liquid to form the batter.

5. The combination of claim 4, wherein the batter is apportioned within the liquid tight container to provide an integral number of servings.

6. The edible item of claim 4, wherein the heterogeneous mixture includes powdered eggs and powdered milk and the liquid is water.

7. The edible item of claim 4, wherein the liquid is milk, the batter including eggs mixed with the heterogeneous mixture.

8. The edible item of claim 1, wherein the batter is in a cooked state having a shape indicative of a flat pancake or a rolled up pancake, the batter in the cooked state being packaged and refrigerated.

9. The edible item of claim 8, wherein fillings are packaged together with the pancakes, the fillings being edible and spreadable on the pancakes.

10. The edible item of claim 1, further comprising flavorings, which are included as part of the heterogeneous mixture.

11. The edible item of claim 1, further comprising a pastry or pie shell containing the heterogeneous mixture.

12. The edible item of claim 1 in combination with a container, wherein the heterogeneous mixture is vacuum sealed in the container.

13. The edible item of claim 1 in combination with a container, wherein the heterogeneous mixture is within in the container and the container is sealed in a manner that prevents deterioration of the heterogeneous mixture that may otherwise occur due to prolonged periods of storage.

14. The combination of claim 13, wherein the heterogeneous mixture is apportioned within the container to provide an integral number of servings.

15. The edible item of claim 1, wherein the heterogeneous mixture appears to have a uniform size powder and common color throughout.

16. A method of producing an edible item, which is palatable to the taste, with nutritional additives that when tasted separately apart from the edible item are not palatable to the taste, comprising forming a plurality of components into a powder state as a heterogeneous mixture that disperses in a liquid to form a batter that is palatable to the taste upon cooking the batter at elevated temperatures to form the edible item, each of the components having ingredients that include the nutritional additives, the ingredients of a first of the components including a cereal coating in granular form, the ingredients of a second of the components including a leavening agent in granular form, the ingredients of a third of the components including a cracker or cookie in granular form, a fourth of the components including wheat germ in granular form he nutritional supplements being suited to improve or maintain nutritional quality and being selected from a group consisting of vitamins, minerals, amino acids, fatty acids, pure chemical compounds, and any combination thereof.

17. A method of claim 16, in combination with packaging the edible item in a container, the heterogeneous mixture being apportioned within the container to provide an integral number of servings.

18. A method of claim 17, wherein the container is liquid tight, the heterogeneous mixture being combined with the liquid inside the container to form the batter.

19. A method of claim 16, further comprising powdered milk and powdered eggs mixed into the heterogeneous mixture.

20. A method of claim 19, wherein the batter includes either powdered eggs and powdered milk with water as the liquid or includes eggs with milk as the liquid.

21. A method of claim 18, further comprising mixing the heterogeneous mixture with the liquid to form the batter, the batter including either powdered eggs and powdered milk mixed with the heterogeneous mixture with water as the liquid or includes eggs mixed with the heterogeneous mixture with milk as the liquid, cooking the batter on the surface heated at elevated temperatures to form a pancake.

22. A method of claim 21, further comprising packaging the pancake and refrigerating the pancake.

23. A method of claim 21, further comprising packaging a filling together with the pancake, the filling being edible and spreadable on the pancake.

24. A method of claim 23, wherein the pancake is rolled to wrap about itself with the filling within confines of the wrap of the pancake.

25. A method of claim 16, further comprising forming a pastry or pie shell that contains the heterogeneous mixture.
